(19) United States
(12) Patent Application Publication
(10) Pub. No.: US 2004/0252746 A1
(43) Pub. Date: Dec. 16, 2004

(54) Method and apparatus for temperature calibration of an incubator

(75) Inventor: Bryan Elwood, Candler, NC (US)

Correspondence Address: BAKER & HOSTETLER LLP, Washington Square, Suite 1100, 1050 Connecticut Avenue, N.W., WASHINGTON, DC, 20036, US

(73) Assignee: Kendro Laboratory Products, LP

(21) Appl. No.: 10/460,357

(22) Filed: Jun. 13, 2003

(51) Int. Cl. G01K 3/00

(52) U.S. Cl. 374/109; 374/1

(57) ABSTRACT

An environmental unit, such as a laboratory incubator, includes a calibration probe integral to the unit. The unit also includes a chamber, a ventilation system, a control sensor, and a CPU. The unit may also include a user interface and a heating element. The calibration probe may be integrated into the chamber of the environmental unit. The calibration probe may be a temperature sensor such as a platinum resistance temperature detector used to calibrate the temperature of the chamber of the unit. The calibration probe communicates the temperature to the control sensor, which communicates the temperature to the CPU. The CPU then adjusts the temperature of the unit.

### FIELD OF THE INVENTION

The present invention relates generally to improving temperature performance in an environmental unit or incubator. More particularly, the present invention relates to using a temperature detector to improve temperature performance in a laboratory incubator.

### BACKGROUND OF THE INVENTION

Environmental units are widely used in industrial and laboratory applications, including, for example, incubators that are used to ensure the safety and/or performance of a cell culture environment for research, clinical, and/or life science applications. Incubators are typically used for growing cultures in a controlled environment wherein both temperature and atmospheric gas concentration are maintained at selected levels. For certain applications it is highly desirable to have both temperature and gas concentrations maintained within strict tolerances while still allowing easy access to the incubator chamber for adding or removing items to and from the chamber or for inspecting the contents of the chamber. Control of environmental variables is desirable to maintain accuracy and reproducibility of incubation results. Typical incubators have used either open-coil heaters within the incubator chamber or water jackets surrounding the incubator chamber wherein the water jacket is heated and heat is transferred to the chamber. However, while such configurations can be effective in heating an incubator, they do not necessarily provide as strict a control on the incubator temperature as is desirable for consistent results.

Conventional air heater type incubators lack the temperature stability of the water jacket type. However, according to prior water jacket technology, water jacket temperature is regulated at the desired incubator internal temperature, and opening the door will cause the air temperature to drop rapidly until the door is closed whereupon the temperature begins to recover. The rate of recovery is proportional to the difference in the water jacket and the internal air temperature, with recovery slowing as the air temperature approaches the water jacket temperature. A typical full recovery requires approximately forty minutes. If the door is opened more than once every forty minutes, the desired operating temperature would never be attained. Moreover, over-controlling the temperature of the water jacket can cause excessive overshoot because of the delayed response of the water jacket to applied heat.

In the use of environmental units, it is often necessary to calibrate the internal temperature of the unit. Typically, calibration is accomplished using a thermocouple and a meter, both external to the environmental unit. When an environmental unit is calibrated several times over its useful life span, it may be calibrated with a different thermocouple each time. This current approach has inherent accuracy limitations, is vulnerable to variation, is time consuming, can be adversely affected by load conditions in the environmental unit, and is subject to varying protocol depending on the user performing the calibration.

Accordingly, it is desirable to provide a method and apparatus that has improved accuracy over the current temperature calibration techniques.

It is also desirable to provide a method and apparatus that is less vulnerable to variation and effects caused by load conditions in the environmental unit.

### SUMMARY OF THE INVENTION

The foregoing needs are met, to a great extent, by the present invention, wherein, in one aspect, an apparatus is provided that in some embodiments improves the accuracy of temperature calibration of an environmental unit.

In one aspect of the invention, to ensure improved temperature performance of an environmental unit such as a laboratory incubator, the air temperature inside the environmental unit is correlated to the control sensor. The correlation is represented by a temperature delta assumed to be constant between the environmental unit and the control sensor. The temperature delta is measured when the environmental unit is first put into use. When an environmental unit is subsequently calibrated, the initial delta is used as a reference to calibrate the environmental unit.

In accordance with one aspect of the present invention, an environmental unit is provided comprising a ventilation system, a chamber, a calibration probe, a control sensor, a user interface, a heating element, and a CPU. The calibration probe is integral with the environmental unit. The calibration probe is used to determine the temperature delta between the environmental unit and the control sensor.

In accordance with another aspect of the present invention, a method is provided for integrating a calibration probe with an environmental unit and calibrating the environmental unit with the calibration probe.

In accordance with still another aspect of the present invention, an environmental unit is provided with means for integrating a calibration probe with an environmental unit and calibrating the environmental unit with the calibration probe.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an environmental unit according to a preferred embodiment of the invention.

FIG. 2 is a schematic view illustrating one embodiment of the invention.

FIG. 3 is a flowchart illustrating steps that may be followed in accordance with one embodiment of the inventive method.

### DETAILED DESCRIPTION

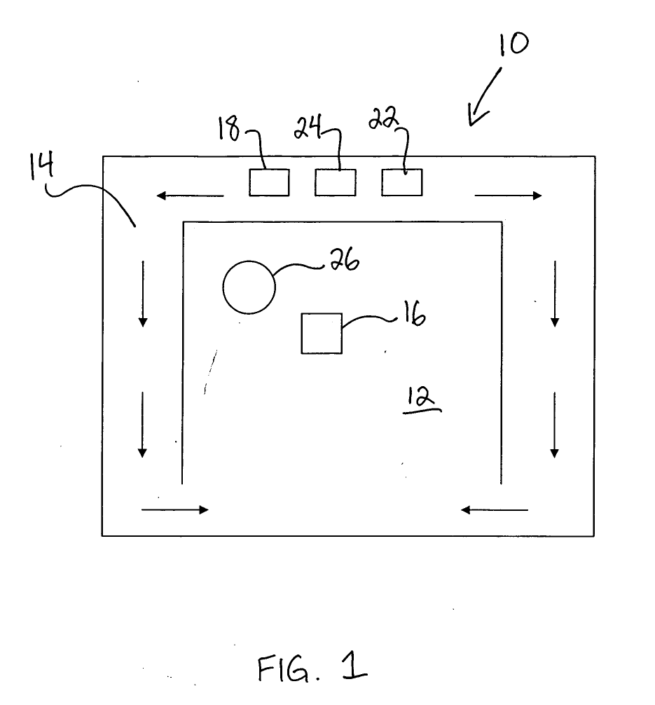

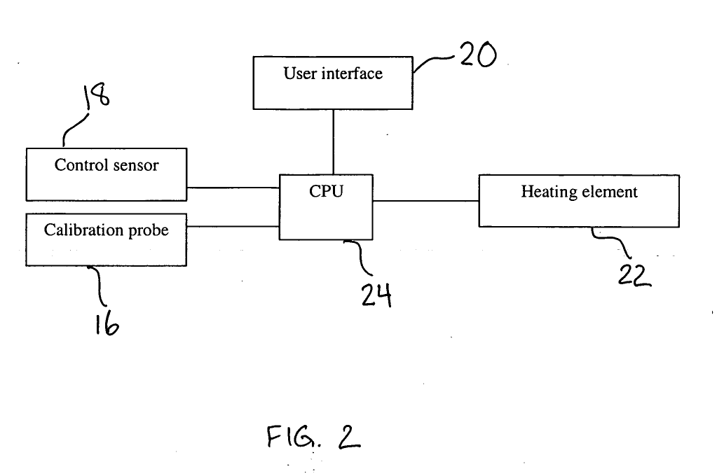

The invention will now be described with reference to the drawing figures, in which like reference numerals refer to like parts throughout. An embodiment of the present inventive apparatus and method is illustrated in FIGS. 1 and 2. An environmental unit 10 is provided with a chamber 12, a ventilation system 14, a calibration probe 16, a control sensor 18, a user interface 20, a heating element 22, and a CPU 24. In a preferred embodiment, the environmental unit 10 is a laboratory incubator.

The chamber 12 is used to store samples or other items in the environmental unit 10.

The ventilation system 14 provides ventilation to the chamber 12 of the environmental unit 10.

The calibration probe 16 is integral with the environmental unit 10. In a one embodiment, the calibration probe 16 is a temperature probe. In another embodiment, the calibration probe 16 is a platinum resistance temperature detector. In yet another embodiment, the platinum resistance temperature detector serves as a calibration device to calibrate the temperature of the environmental unit.

Having the calibration probe 16 integral to the environmental unit 10 improves the accuracy of temperature calibration of the environmental unit 10. Having the calibration probe 16 integral to the environmental unit 10 also reduces the variation between multiple calibrations that can result if a different calibration probe were to be used each time. And, having the calibration probe 16 integral to the environmental unit 10 also reduces the effects caused by load conditions, because the calibration can be done with samples or other items present in the environmental unit 10.

The calibration probe 16 may be mounted 30 anywhere inside the ventilation system 14 or the chamber 12 so that it measures 34 the temperature of air that is representative of air in the chamber 12. In one embodiment, the calibration probe 16 is mounted 30 in the chamber 12 via an access port 26. The access port 26 permits the calibration probe 16 to be removed from the chamber 12 when the calibration is complete and mounted on the back of the environmental unit 10 for use as an ambient conditions probe. The calibration probe 16 may be permanently mounted or may be removably mounted. Where the calibration probe 16 is removably mounted, it may be mounted with a pinch mount or by any other suitable means. Where the calibration probe 16 is removably mounted, it may be mounted in the ventilation system 14 or the chamber 12 for calibration of the environmental unit 10, and then it may be mounted elsewhere for storage or for use as an ambient conditions probe. When the calibration probe 16 is used as an ambient conditions probe, it is preferably mounted on the back of the environmental unit 10.

The control sensor 18 is preferably located in the ventilation system 14 of the environmental unit 10 so as not to interfere with the usable space of the chamber 12.

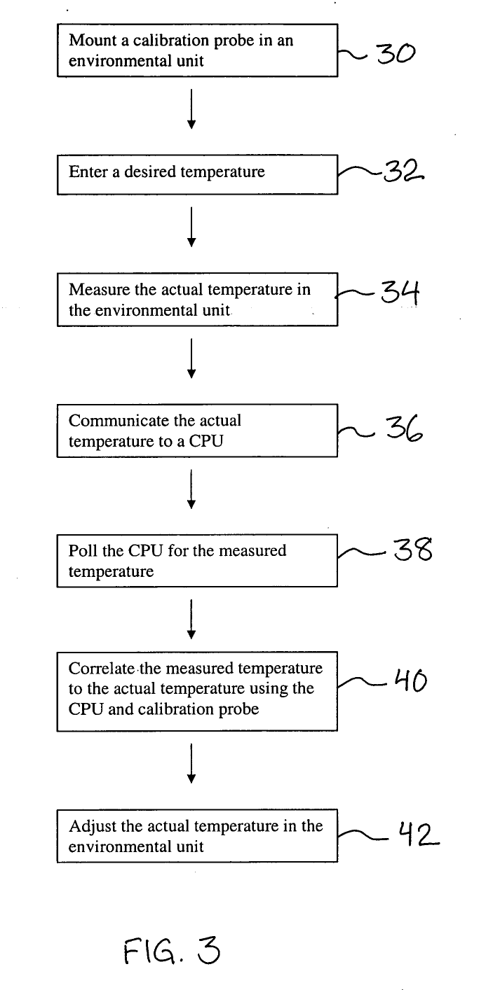

Referring to FIG. 3, a method for calibrating an environmental unit 10 is provided where the calibration probe 16 measures 34 the actual conditions of the air in the environmental unit 10. In one embodiment, the calibration probe 16 is mounted 30 in an environmental unit. A user enters 32 the desired temperature via a user interface 20. The calibration probe 16 measures 34 the actual temperature of the air in the environmental unit 10. The control sensor 18 is mounted in the ventilation system 14. The control sensor 18 measures the temperature of the air in the ventilation system 14.

The CPU 24 polls 36 the calibration probe 16 for the actual temperature 34 measured in the chamber 12 of the environmental unit 10. Likewise, the CPU 24 polls 38 the control sensor 18 for the temperature measured in the ventilation system 14. The CPU 24 then derives a correlation 40 between these parameters.

The CPU 24 converts the communication from the control sensor 18 and adjusts 42 the temperature in the environmental unit 10. It will be understood that there are several means to adjust the temperature known to one skilled in the art. In one embodiment, this adjustment 42 is accomplished by turning on or off the heating element 22. The heating element 22 will be turned on if the measured temperature is lower than the desired temperature. The heating element 22 will be turned off if the measured temperature is greater than the desired temperature.

For example, an option may be available for the operator to choose an option such as “adjust now” after entering a desired temperature 32 on the user interface 20. The temperature would be measured 34, the actual temperature would be communicated 36 to the CPU 24 and the CPU 24 would poll 38 the control sensor 18 for the measured temperature. The CPU 24 would thereby capture the correlation 40 upon a directive from the operator. The measured temperature and correlation 40 would then be processed by the CPU 24 and the temperature would be adjusted 42. Or, the temperature of the environmental unit 10 may be displayed or printed. Here, the operator may manually adjust 42 the temperature. Others means to adjust the temperature will be know to those skilled in the art.

In another embodiment, the calibration steps can be integrated into a setup routine for the environmental unit 10. In this embodiment, the same calibration steps are performed, as described above, when the environmental unit 10 is first put into use.

That is, a routine is offered to the operator that calibrates the environmental unit 10 by measuring 34 a condition such as temperature in the environmental unit with the calibration probe 16. The calibration probe 16 communicates 36 the temperature of the air in the environmental unit 10 to the CPU 24. The CPU 24 polls 38 the control sensor 18. The control sensor 18 communicates 40 the temperature of the air in the ventilation system 14 to the CPU 24. The CPU 24 would establish the correlation 40 between these values after some stabilization period. Utilizing this correlation, the CPU 24 converts the communication from the control sensor 18 and adjusts 42 the temperature in the environmental unit 10.

Although an example of the environmental unit 10 is shown using a platinum resistance temperature detector as the calibration probe 16, it will be appreciated that other calibration probes can be used. Also, although the calibration probe 16 shown is useful to calibrate the temperature of the environmental unit 10, it will be appreciated that the calibration probe 16 can also be used to measure other conditions in the environmental unit 10 or calibrate other parameters of the environmental unit 10. Additionally, although the calibration probe 16 is described as measuring conditions of the air present in the environmental unit 10, it will be appreciated that gases other than air may be the ambient atmosphere of the environmental unit 10.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An environmental unit, comprising:
a chamber;
a ventilation system connected to the chamber;
a calibration probe located in the chamber;
a control sensor; and
a CPU,
wherein the CPU communicates with the control sensor and the calibration probe.

2. (Canceled)

3. The environmental unit of claim 1, wherein the environmental unit is an incubator.

4. The environmental unit of claim 1, wherein the environmental unit further comprises a user interface and a heating element.

5. The environmental unit of claim 1, wherein the calibration probe is a temperature sensor.

6. The environmental unit of claim 5, wherein the temperature sensor is a platinum resistance temperature detector.

7. A method for calibrating an environmental unit, comprising the steps of:
integrating a calibration probe within a chamber, wherein the chamber is located in the environmental unit; and
calibrating the environmental unit in response to data from the calibration probe.

8. (Canceled)

9. The method of claim 7, wherein the environmental unit is an incubator.

10. The method of claim 7, wherein the calibration probe is a temperature sensor.

11. The method of claim 10, wherein the temperature sensor is a platinum resistance temperature detector.

12. The method of claim 7, wherein the calibrating step further comprises the steps of:
entering a desired chamber condition;
measuring an actual chamber condition;
communicating the actual chamber condition to a CPU;
deriving a relationship between the actual chamber condition and a control condition; and
adjusting the actual chamber condition in response to the relationship.

13. The method of claim 12, wherein the calibrating step further comprises the step of polling a control sensor for the control condition measured in a control location.

14. The method of claim 12, wherein the adjusting step further comprises modulating a heating element.

15. The method of claim 12, wherein the desired chamber condition is a temperature and the actual chamber condition is a temperature.

16. An environmental unit, comprising:
means for determining a condition of a chamber, wherein the means for determining is located in the chamber and the chamber is located within the environmental unit; and
means for calibrating the chamber in response to the means for determining.

17. (Canceled)

18. The environmental unit of claim 16, wherein the environmental unit is an incubator.

19. The environmental unit of claim 16, wherein the means for determining is a temperature sensor.

20. The environmental unit of claim 19, wherein the temperature sensor is a platinum resistance temperature detector.

21. The environmental unit of claim 16, wherein the calibrating means further comprises:
means for entering a desired chamber condition;
means for measuring an actual chamber condition;
means for communicating the actual chamber condition to a CPU; and
means for deriving a relationship between the actual chamber condition and a control condition.
means for adjusting the actual chamber condition in response to the relationship.

22. The environmental unit of claim 21, wherein the desired chamber condition is a temperature and the actual chamber condition is a temperature.

23. The environmental unit of claim 21, wherein the adjusting means further comprises means for modulating a heating element.

24. The environmental unit of claim 21, wherein the calibrating means further comprises means for polling a control sensor for the control condition measured in a control location.

25. The environmental unit of claim 1, wherein the control sensor is located in a ventilation system.

26. The environmental unit of claim 1, wherein the control location is a ventilation system.

27. The environmental unit of claim 1, wherein the control sensor is a temperature sensor.

28. The method of claim 13, wherein the control sensor is located in a ventilation system.

29. The method of claim 13, wherein the control location is a ventilation system.

30. The method of claim 13, wherein the control sensor is a temperature sensor.

31. The environmental unit of claim 24, wherein the control sensor is located in a ventilation system.

32. The environmental unit of claim 24, wherein the control location is a ventilation system.

33. The environmental unit of claim 24, wherein the control sensor is a temperature sensor.
